(19) United States
(12) Patent Application Publication
(10) Pub. No.: US 2025/0207648 A1
(43) Pub. Date: Jun. 26, 2025

(54) A BRAKE COMPONENT

(71) Applicant: Airbus Operations Limited, FILTON, BRISTOL (GB)

(72) Inventor: Marco NAGLIATI, FILTON, BRISTOL (GB)

(21) Appl. No.: 18/848,446

(22) PCT Filed: Mar. 29, 2023
(86) PCT No.: PCT/EP2023/058204

§ 371 Date: Sep. 18, 2024

(30) Foreign Application Priority Data
Mar. 30, 2022 (GB) 2204557.9

(51) Int. Cl. F16D 65/18; F16D 69/02; F16D 125/06

(52) U.S. Cl. CPC F16D 65/18; F16D 69/028; F16D 2125/06

(57) ABSTRACT

Disclosed is a brake component (151) comprising a composite material (200), the composite material comprising a matrix (202) and reinforcements (201) embedded in and supported by the matrix, wherein the matrix is a glass-ceramic matrix. Also disclosed is a braking system, an aircraft braking system, an aircraft and a method of operating an aircraft.

### CROSS-REFERENCES TO RELATED APPLICATIONS

This application is a national phase of International Patent Application No. PCT/EP2023/058204, filed on Mar. 29, 2023, which claims the benefit of Great Britain Patent Application No. 2204557.9, filed on Mar. 30, 2022, the entire disclosures of which are incorporated herein by way of reference.

### FIELD OF THE INVENTION

The present invention relates to a brake component, a braking system, an aircraft braking system, an aircraft and a method of operating an aircraft.

### BACKGROUND OF THE INVENTION

Aircraft braking systems are made up of a number of components, each designed for a different function within the braking system. Of course, braking systems for aircraft are designed especially with safety and reliability, performance and overall weight in mind.

Braking component parts, especially ones that abut against other components to cause movement, or be moved themselves, need to be made out of a very strong material. For example, brake pistons, piston bushings, insulator assemblies, piston caps, piston cavity walls and pin retainers have traditionally been made out of stainless steel.

However, stainless steel is a relatively dense material and so the resulting brake components and overall braking system can be very heavy. In addition, for moving components such as brake pistons, having the component made out of stainless steel, mean the component has a lot of inertia and so leads to the overall braking system being designed to withstand and cope with the higher inertia, meaning the overall weight of the system increases.

Stainless steel also possesses a relatively high coefficient of thermal expansion. This means that when it is heated up, it expands. And when it cools, it shrinks. This change in dimension of the material means that it is difficult to provide for effective sealing of the component against another component. This might mean the performance of the braking system is compromised or that additional sealing, and the resultant complexity, in terms of design, manufacture, maintenance and repair, had to be provided.

Another issue with the use of stainless steel is that it has a relatively high thermal conductivity. This means that the temperature of any hydraulic brake fluid, for example if near or adjacent to the stainless steel component, is heated up by that component. This can cause the braking fluid to thermal degrade and need earlier replacement than it would otherwise. Stainless steel also has only a certain inherent level of corrosion resistance.

More recently, there has been limited advances in using other materials for some brake components. For example, in FR 2829817, a glass (e.g. silica) ceramic material has been suggested to be used as the material for an automotive brake piston. However, there are concerns that such a material may be relatively brittle. As another example, in U.S. Pat. No. 6,146,727, a composite material has been suggested to be used for a brake piston. Here, the composite material comprises fiber reinforcements in a phenolic matrix. However, this material may not provide a desired level of heat resistance, thermal stability, chemical stability and/or resistance to aggressive environments (such as those found adjacent to a brake fluid). As a final example, in US 2020/0393007, there is a suggestion to use a composite material with a ceramic matrix and glass fibers as the material for a brake caliper. However, this material may provide a level of thermal expansion higher than desired and/or a level of toughness, thermal shock resistance and/or impact resistance lower than desired. Furthermore, it is not possible to tune the properties of the material to meet different requirements.

The present invention seeks to mitigate the above-mentioned problems. Alternatively or additionally, the present invention seeks to provide an improved brake component.

### SUMMARY OF THE INVENTION

A first aspect of the present invention provides a brake component, wherein the brake component is a brake piston, piston bushing, insulator assembly, piston cap, pin retainer or a wall of a piston cavity, the brake component comprising a composite material, the composite material comprising a matrix and reinforcements embedded in and supported by the matrix, wherein the matrix is a glass-ceramic matrix.

Such a brake component has a lower density than other traditional materials, such as stainless steel. This enables the brake component to be lighter. This is especially useful for use in aircraft brake components. In addition, a lighter brake component means it has less inertia. This is especially useful if the brake component is a moving part such as a brake piston or piston cap, for example. Also, such a brake component has a lower coefficient of thermal expansion. This means that the brake component, for the same in-service temperature range, expands and contracts less and so is better at sealing. Such a brake component also has a lower thermal conductivity. This means that a brake fluid (e.g. hydraulic fluid) adjacent or near to the brake component may be heated less and thus reduce the thermal degradation of the fluid. Another advantage of such a brake component, is that it has a higher corrosion resistance. All these advantages enable the brake component to enable a lower operating and maintenance cost and enable a smoother operation.

Having a glass-ceramic matrix has the advantage of having much greater thermal stability than, for example, a phenolic matrix. For example, a phenolic matrix may begin to degrade at 300-350° C. However, PyroSic™, which uses a glass-ceramic matrix features a long term temperature resistance up to 650° C. and shorter term exposure in excess of 1000° C. It, and glass-ceramic matrix materials in general, also exhibit higher chemical stability and resistance to aggressive environments. In addition, they exhibit a lower thermal expansion, near zero, and have a higher toughness than a ceramic matrix. They are also more resistant to thermal shock and have a high impact resistance. Depending on the microstructure and the chemical composition of glass-ceramic matrices, their properties can be tuned to meet demanding requirements. For example, manufacturers can improve these properties by changing the chemical mixture of the glass-ceramic, or by modifying the production process, such as the length of time the material is thermally treated.

Preferably, the glass-ceramic matrix is formed from controlled crystallization of glass into a polycrystalline material. Alternatively, the glass-ceramic matrix may be amorphous or partially amorphous.

For example, the glass-ceramic matrix may comprise the Li2O×Al2O3×nSiO2 system (LAS system), the MgO×Al2O3×nSiO2 system (MAS system), or the ZnO×Al2O3×nSiO2 system (ZAS system).

Preferably, the reinforcements comprise fiber reinforcements.

Alternatively, or additionally, the reinforcements may comprise particulate reinforcements.

Preferably, the fiber reinforcements comprise silicon carbide, carbon or aluminum oxide fibers.

Preferably, the fiber reinforcements comprise ceramic fibers, such as silicon carbide fibers. Ceramic fibers have much greater thermal stability than glass fibers. For example, SiC fibers can withstand temperatures up to 1,900° C., while glass fibers degrade from exposure at 550° C.

Preferably, the fiber reinforcements provide a fiber volume fraction of the composite material of between 30% and 70%, preferably between 40% and 60% and more preferably between 45% and 55%.

Preferably, the brake component is a unitary part, made out of the composite material.

In other words, the brake component consists of the composite material, with no other material used. Of course, the brake component could be joined or otherwise attached to another brake component to form a larger assembly of a braking system.

Alternatively, the composite material is in the form of an external layer providing an external surface of the brake component.

In other words, the brake component comprises an external layer made of the composite material and an internal portion made of a different material. The external layer may be thought of as a heat shield for the brake component.

Preferably, the brake component is a component that is located adjacent to a brake fluid in use in a braking system.

In other words, the brake component is located adjacent to the hydraulic fluid of the braking system. If the brake component comprises an external layer of composite material, the external layer may be located adjacent to the brake fluid in use.

Preferably, the brake component is a component that, when in use in a braking system, abuts against a second brake component and urges the second brake component to move.

If the brake component comprises an external layer of composite material, the external layer may be located in an abutting region of the brake component such that it is the external layer that abuts the second brake component.

Alternatively, the brake component is a component that, when in use in a braking system, is abutted against by a second brake component and is urged to move by the second brake component.

If the brake component comprises an external layer of composite material, the external layer may be located in an abutted region of the brake component such that it is the external layer that is abutted against by the second brake component.

Preferably, the brake component is a brake piston, piston bushing, insulator assembly, piston cap, pin retainer or a wall of a piston cavity. Brake pistons are the component responsible for the brake pressure plate making contact with the next brake rotor and consequently engage all discs of the heat sink, to slow the aircraft by developing friction between the surfaces in contact. They are activated by fluid traveling in the piston's hydraulic fluid cavity. A piston bushing is the component that acts as the cylinder for the piston. A piston cap is the part of the piston in direct contact with the thermal pack touching the brake pressure plate. It is the first thermal barrier to the rest of the system. An adjuster pin is the component that keeps the spring guide in position during the braking. A pin retainer is the component that fixes the adjuster pin and fixes the starting point of the piston stroke. A spring guide is a component that stops damages to the spring and helps keep the piston in place.

Preferably, the brake component is an aircraft brake component.

According to a second aspect of the invention, there is provided a braking system comprising one or more brake components as described above.

According to a third aspect of the invention, there is provided an aircraft braking system comprising one or more brake components as described above.

According to a fourth aspect of the invention, there is provided an aircraft comprising one or more brake components as described above or a braking system as described above.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the invention will now be described, by way of example only, with reference to the accompanying drawings, in which:

FIG. 1 shows a cross-sectional view of an upper half of a braking assembly of an aircraft, according to a first embodiment of the invention;

FIG. 2 shows an enlarged view of the brake piston assembly of the braking assembly of FIG. 1;

FIG. 3 shows a schematic view of an alternative configuration of a piston end portion;

FIG. 4 shows a schematic view of an alternative configuration of an insulator assembly;

FIG. 5 shows a schematic view of an alternative configuration of a piston cavity;

FIG. 6 shows a schematic view of a composite material used in the first embodiment of FIGS. 1 and 2 or the alternative embodiments of FIGS. 3, 4 and 5; and

FIG. 7 shows an aircraft including the brake assembly of FIG. 1.

### DETAILED DESCRIPTION OF THE PREFERRED EMBODIMENTS

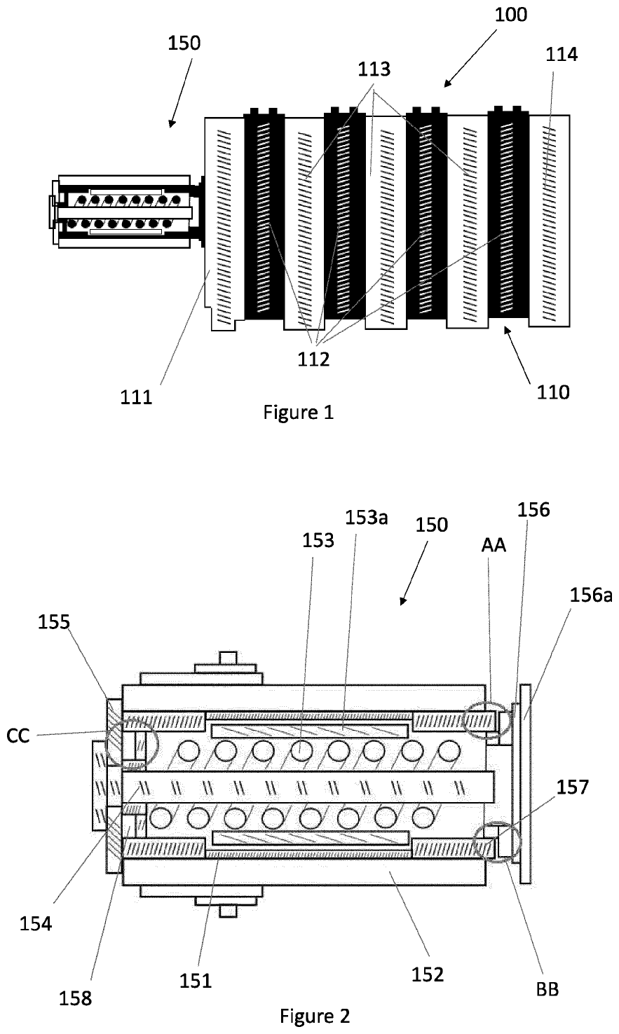

FIG. 1 shows a cross-sectional view of an upper half of a braking assembly 100 of an aircraft 400, according to a first embodiment of the invention.

The brake assembly comprises many brake components, including a carbon heat sink 110 made up of a number of alternating rotors 112 and stators 113, with a pressure plate 111 at a left hand side (as shown) adjacent a piston assembly 150 and a thrust plate 114 at a right hand side (as shown).

The piston assembly 150 is shown enlarged in FIG. 2. It is one of 12 in the brake assembly 100, distributed circumferentially.

The pressure plate 111, rotors 112, stators 113 and thrust plate 114 together make part of the torque transmission system of the braking assembly 100. When braking is demanded, the piston assembly 150 engages the pressure plate 111. This pushes the rotors 112 and stators 113 together in order to create the braking torque by way of friction between the rotors 112 and stators 113. The pressure plate 111 and thrust plate 114 are also pressed against the rotors 112 and contribute to the generation of braking torque in the same way as a stator 113. Accordingly the pressure plate 111, rotors 112, stators 113 and thrust plate 114 can be said to be part of the torque path of the braking assembly 100. The piston assembly 150 and its component parts are not part of the torque path since they do not generate or transmit braking torque.

In contrast the piston assembly 150 is not part of the torque transmission system or torque path-instead, it is part of the energy transmission system. Energy, typically in the form of pressure within a hydraulic fluid, is provided to the piston assembly 150 in order to engage the pressure plate 111 and thereby activate the braking system 100. The energy transmission system comprises those parts of the braking system 100 that deliver energy to engage the braking system 100 but do not form part of the torque transmission system.

The piston assembly 150 comprises many brake components, including a brake piston 151 located inside a piston bushing 152 and moveable along it. A piston spring 153 surrounds the piston 151 and provides a biasing force to the piston 151 to retain it non-actuating state (i.e. towards the left hand side (as shown) of the bushing). The piston spring 153 is held in place by a spring guide 153a.

An adjuster pin 154 inserted from the left hand side (as shown) holds the piston 151 and spring 153 in place and a pin retainer 155 retains the pin 154. Adjacent the pin retainer 155 is a piston cavity 158 in a left hand side wall (as shown) of the piston 151. In use, brake fluid flows into this cavity 158 and acts to move the piston 151 within the bushing 152 (and against the piston spring 153 biasing force) towards its actuating state towards the right hand side (as shown) of the bushing.

On the right side (as shown) of the piston assembly 150 is an insulator assembly 156 including a piston cap 156a. This is acted upon by an end portion 157 of the piston 151 when the piston is in its actuating state. This moves the insulator assembly 156 towards the pressure plate 111 and the piston cap 156a acts upon it to brake a corresponding wheel of the aircraft 400.

The energy transmission system comprises those parts of the braking system that are involved in the delivery of energy for engaging the braking system. Accordingly all parts of the piston assembly 150 are part of the energy transmission system. For example, although the piston bushing 152 or spring 153 do not themselves transmit energy to the braking system 100 they form part of the apparatus that does so.

Many of the components of the brake assembly 100 are made of traditional (e.g. metallic) materials.

However, the piston 151 is made from a composite material 200, shown schematically in FIG. 6. The composite material 200 is called PyroSic™ and is produced by the Pyromeral Systems Company. It comprises a number of fiber reinforcements 201. These fiber reinforcements are made of silicon carbide fibers and in each layer are orientated in a required orientation, embedded and supported by a matrix 202 of glass ceramic.

This composite material 200 is used to form the piston, such that the entire piston 151 is made of the composite material 200.

The material 200 has a density 3.8 times lower than stainless steel, a coefficient of thermal expansion between 3 and 6 time lower and a thermal conductivity between 17 and 26 time lower.

As an illustration of a potential weight saving, if made out of stainless steel, each of the 12 pistons 151 might weigh 0.38 kg. This gives a total piston weight per brake of 4.6 kg and a total piston weight for the whole aircraft 400 (12 brakes) of 55 kg. If made out of the composite material 200, the weight would be 14.5 kg; a weight saving of 41 kg (nearly 75%).

Not only does using material 200 provide a weight saving, it also means the pistons 151 have less inertia. They also have a lower coefficient of thermal expansion and so provide better sealing.

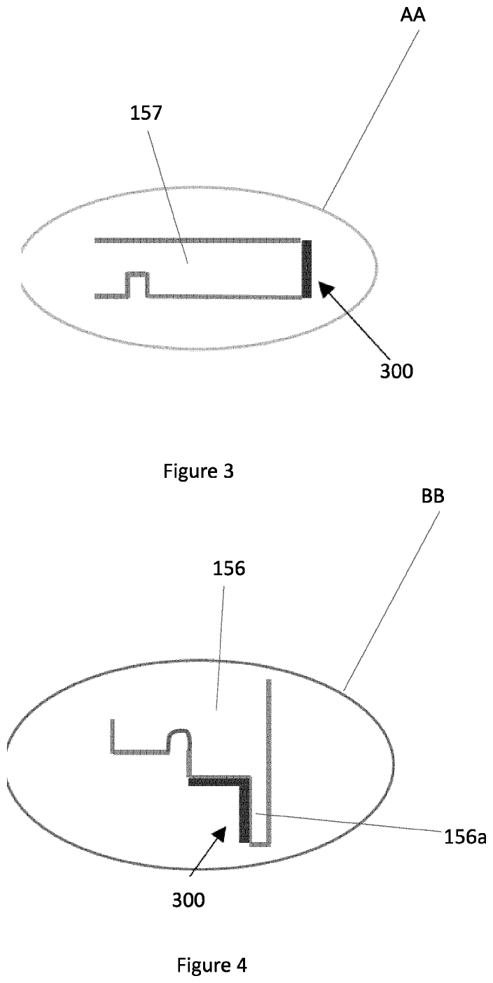

FIG. 3 shows a schematic view of an alternative configuration of a piston end portion 157 and is a schematic enlargement of equivalent area AA shown in FIG. 2.

Here, the piston 151 is primarily made out of stainless steel. However, the (right side surface, as shown) end portion 157 of the piston 151 (in other words, the portion of the piston 151 that abuts against the insulator assembly 156) is covered with a heat shield 300. The heat shield 300 is a thin layer of the composite material 200 that is adhered to the metallic part of the piston 151.

Here, the material 200 is used as a heat shield 300 and minimizes the piston 151 heating up where it abuts against the insulator assembly 156 and also provides better sealing.

FIG. 4 shows a schematic view of an alternative configuration of an insulator assembly 156 and is a schematic enlargement of equivalent area BB shown in FIG. 2.

Here, the insulator assembly 156 is primarily made out of stainless steel. However, an external underside and a left side facing surface (in other words, the surfaces of the insulator assembly 156 that are abutted against by the piston 151) are covered with a heat shield 300. The heat shield 300 is a thin layer of the composite material 200 that is adhered to the metallic part of the insulator assembly 156.

Here, the material 200 is used as a heat shield 300, and minimizes the insulator assembly 156 heating up where it is abutted against by the piston 151 and also provides better sealing.

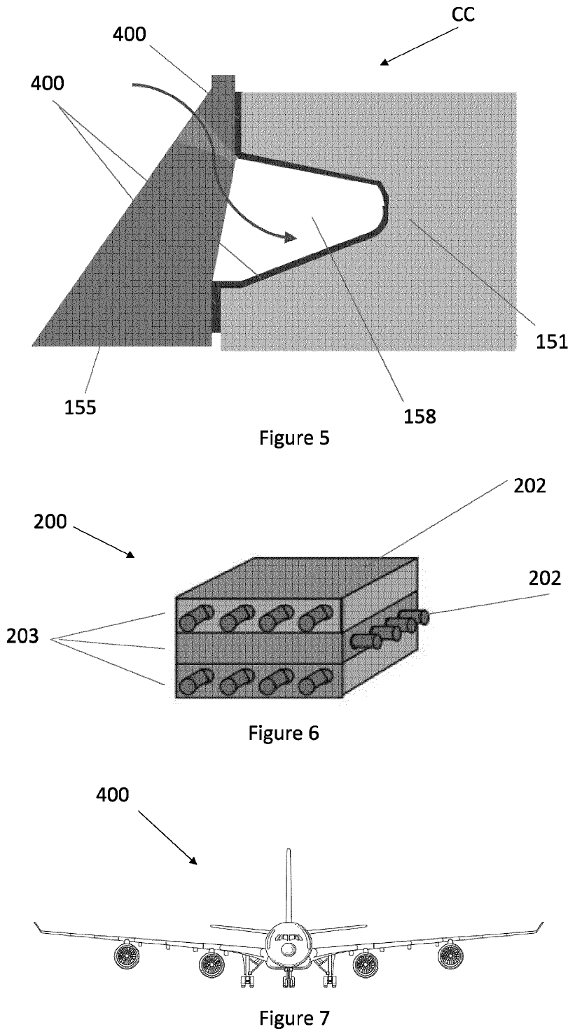

FIG. 5 shows a schematic view of an alternative configuration of a piston cavity 158 and is a schematic enlargement of equivalent area CC shown in FIG. 2.

Here, the piston 151 is primarily made out of stainless steel. However, the external surfaces providing a piston cavity 158 (where hydraulic brake fluid flows) are covered with a heat shield 300. The heat shield 300 is a thin layer of the composite material 200 that is adhered to the metallic part of the piston 151.

Here, the heat shield 300 is in contact with the hydraulic brake fluid and, as the composite material 200 has a lower thermal conductivity than the stainless steel underneath, it leads to reduction of the in service temperature and thermal degradation of the hydraulic brake fluid. The material 200 also has a better corrosion resistance than stainless steel and so is less affected by contact with the hydraulic brake fluid.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

There may be any suitable number of piston assemblies in each brake assembly, for example 4 to 15. There may be any suitable number of brake assemblies per aircraft.

Any number and variety of brake components that form part of the energy transmission system (and/or heat shields of the brake components) in each brake or piston assembly may be made of the composite material 200, such as pistons, piston bushing, insulator assembly, piston cap, pin retainer and/or a wall of a piston cavity.

The material 200 may instead be made with carbon fibers 201, for example, the material may be PyroKarb™, produced by the Pyromeral Systems Company. The material may be made with aluminum oxide fibers. The material 200 may be made with any suitable fiber reinforcements.

The material 200 may be made with any suitable glass ceramic matrix 202, such as the Li2O×Al2O3×nSiO2 (LAS system), MgO×Al2O3×nSiO2 system (MAS system), or the ZnO×Al2O3×nSiO2 system (ZAS system).

The above embodiments are to be understood as illustrative examples of the invention. Equivalents and modifications not described above may also be employed without departing from the scope of the invention, which is defined in the accompanying claims.

It is to be understood that any feature described in relation to any one embodiment may be used alone, or in combination with other features described, and may also be used in combination with one or more features of any other of the embodiments, or any combination of any other of the embodiments.

It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

It should be noted that throughout this specification, “or” should be interpreted as “and/or”.

Although the invention has been described above mainly in the context of a fixed-wing aircraft application, it may also be advantageously applied to various other applications, including but not limited to applications on vehicles such as helicopters, drones, trains, automobiles and spacecraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-16. (canceled)

17. A brake component, wherein the brake component is a brake piston, piston bushing, insulator assembly, piston cap, pin retainer or a wall of a piston cavity, the brake component comprising:
a composite material, the composite material comprising a matrix and reinforcements embedded in and supported by the matrix, wherein the matrix is a glass-ceramic matrix.

18. The brake component as claimed in claim 17, wherein the glass-ceramic matrix is formed from controlled crystallization of glass into a polycrystalline material.

19. The brake component as claimed in claim 17, wherein the reinforcements comprise fiber reinforcements.

20. The brake component as claimed in claim 19, wherein the fiber reinforcements comprise silicon carbide, carbon or aluminum oxide fibers.

21. The brake component as claimed in claim 19, wherein the fiber reinforcements provide a fiber volume fraction of the composite material of between 30% and 70%.

22. The brake component as claimed in claim 17, wherein the brake component is a unitary part, made out of the composite material.

23. The brake component as claimed in claim 17, wherein the composite material comprises an external layer providing an external surface of the brake component.

24. The brake component as claimed in claim 17, wherein the brake component is a brake piston.

25. The brake component as claimed in claim 17, wherein the brake component is an aircraft brake component.

26. A braking system comprising:
one or more brake components as claimed in claim 17.

27. An aircraft braking system comprising:
one or more brake components as claimed in claim 17.

28. An aircraft comprising:
one or more brake components as claimed in claim 17.
